(19) United States
(12) Patent Application Publication
(10) Pub. No.: US 2020/0037033 A1
(43) Pub. Date: Jan. 30, 2020

(54) INTERACTIVE IMAGE FILE FORMAT

(71) Applicant: INTERNATIONAL BUSINESS MACHINES CORPORATION, Armonk, NY (US)

(72) Inventors: Florian Pinel, New York, NY (US); Robert N. Redmond, Smyrna, GA (US); William Stirling Spann, III, Atlanta, GA (US)

(21) Appl. No.: 16/044,735

(22) Filed: Jul. 25, 2018

(51) Int. Cl. H04N 21/4725; H04N 19/176; G06T 13/00; G06Q 30/02; G06F 17/30; G06F 3/0484

(52) U.S. Cl. CPC H04N 21/4725; H04N 19/176; G06T 13/00; G06T 2210/32; G06F 17/3005; G06F 3/04842; G06Q 30/0241

(57) ABSTRACT

Embodiments of the present invention disclose a method, computer program product, and system for an interactive image file. The computer may receive at least one image and a plurality of business logic associated with the at least one image. The at least one image may be encoded into at least one image block, wherein the at least one image block contains a plurality of images stored within a single file at different offsets. A table of contents may be generated for the at least one image block, wherein the table of contents contains a list of the at least one image block, a location of the at least one image block, and an identifier for each of the at least one image block. A single image file may be created for the interactive image file.

### BACKGROUND

The present invention relates generally to the field of computing, and more particularly to interactive images.

An interactive image refers to products and services on digital computer-based systems that respond to a user's actions by presenting content such as text, another image, an animation, a video, audio, and other such context. If the image represents an advertisement, this would go beyond static content by letting users interact with the advertisement without being taken to a different site. An interactive image can run in places where only images are allowed. This lifts constraints on existing systems and customization. Interactive images allow for a dynamic experience within a single image.

### BRIEF SUMMARY

Additional aspects and/or advantages will be set forth in part in the description which follows and, in part, will be apparent from the description, or may be learned by practice of the invention.

Embodiments of the present invention disclose a method, computer program product, and system for an interactive image file. The computer may receive at least one image and a plurality of business logic associated with the at least one image. The at least one image may be encoded into at least one image block, wherein the at least one image block contains a plurality of images stored within a single file at different offsets. A table of contents may be generated for the at least one image block, wherein the table of contents contains a list of the at least one image block, a location of the at least one image block, and an identifier for each of the at least one image block. A single image file may be created for the interactive image file.

### BRIEF DESCRIPTION OF THE DRAWINGS

These and other objects, features and advantages of the present invention will become apparent from the following detailed description of illustrative embodiments thereof, which is to be read in connection with the accompanying drawings. The various features of the drawings are not to scale as the illustrations are for clarity in facilitating one skilled in the art in understanding the invention in conjunction with the detailed description. In the drawings:

FIG. 1 is a functional block diagram illustrating a system for an interactive image file format, in accordance with an embodiment of the present invention.

FIG. 2 is a flowchart depicting operational steps of the system for generating the interactive image file format of FIG. 1, in accordance with an embodiment of the present invention.

FIG. 3 is a flowchart depicting operational steps of the system for the implementation of the system for the interactive image file format of FIG. 1, in accordance with an embodiment of the present invention.

FIG. 4 is an example of an interactive image, where the present invention can be implemented.

FIG. 5 is a block diagram of components of a computing device of the system for the interactive image file format of FIG. 1, in accordance with embodiments of the present invention.

FIG. 6 depicts a cloud computing environment according to an embodiment of the present invention.

FIG. 7 depicts abstraction model layers according to an embodiment of the present invention.

### DETAILED DESCRIPTION

Detailed embodiments of the claimed structures and methods are disclosed herein; however, it can be understood that the disclosed embodiments are merely illustrative of the claimed structures and methods that may be embodied in various forms. This invention may, however, be embodied in many different forms and should not be construed as limited to the exemplary embodiments set forth herein. In the description, details of well-known features and techniques may be omitted to avoid unnecessarily obscuring the presented embodiments.

The terms and words used in the following description and claims are not limited to the bibliographical meanings, but, are merely used to enable a clear and consistent understanding of the invention. Accordingly, it should be apparent to those skilled in the art that the following description of exemplary embodiments of the present invention is provided for illustration purpose only and not for the purpose of limiting the invention as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces unless the context clearly dictates otherwise.

Embodiments of the present invention relate to the field of computing, and more particularly to interactive images. The following described exemplary embodiments provide a system, method, and program for, among other things, an interactive image file format that stores all aspects of the interactive image in a single image file. Therefore, the present invention has the capacity to improve the technical field of computer functionality by more efficiently storing an interactive image file through storage as a single image file rather than multiple entities.

As previously described, an interactive image refers to products and services on digital computer-based systems that respond to a user's actions by presenting content such as text, another image, an animation, a video, audio, and other such context. If the image represents an advertisement, this would go beyond static content by letting users interact with the advertisement without being taken to a different site. An interactive image can run in places where only images are allowed. This lifts constraints on existing systems and customization. Interactive images allow for a dynamic experience within a single image.

Systems for delivering and enabling interactivity with images have software that animates a set of images and allows a 360-degree view of the image. These images are stored on a server. There are also three-dimensional interactive image modeling systems where the desired output image is processed by an image assembly service. These systems require the image rendering to be done on the server side. The new images are either fetched from a server or they are generated on the server resulting in slower delivery. As such, it may be advantageous to, among other things, implement a system for an interactive image file format to more efficiently deliver the interactive image as in a single image file format.

According to one embodiment, an interactive image file format may embed image blocks and business logic in the file to deliver a dynamic experience within a single image file. The images may be received from a program designer who creates the images. Business logic that is associated with the images may be received from the program designer who created the images, or a program developer. Business logic may be code, script, or a visualization that explains how the image is to be displayed and what user events it can handle. The script may call an external application-programming interface and activate different image blocks based on the response. For example, the script could be JavaScript and each image block could be a JavaScript object. The images may be encoded as image blocks. The image blocks may be different images stored within a single file at different offsets. The images can be encoded in an existing image format, such as JPEG. A table of contents may then be generated for the stored images. The table of contents may contain a list of all of the image blocks, their location in the file, and an identifier for each of them. The identifier may contain addresses to parts of the image. For example, the address could be a number identifier for the background or what is displayed on the image. A single image file may be created that includes the image blocks, the business logic, and the table of contents.

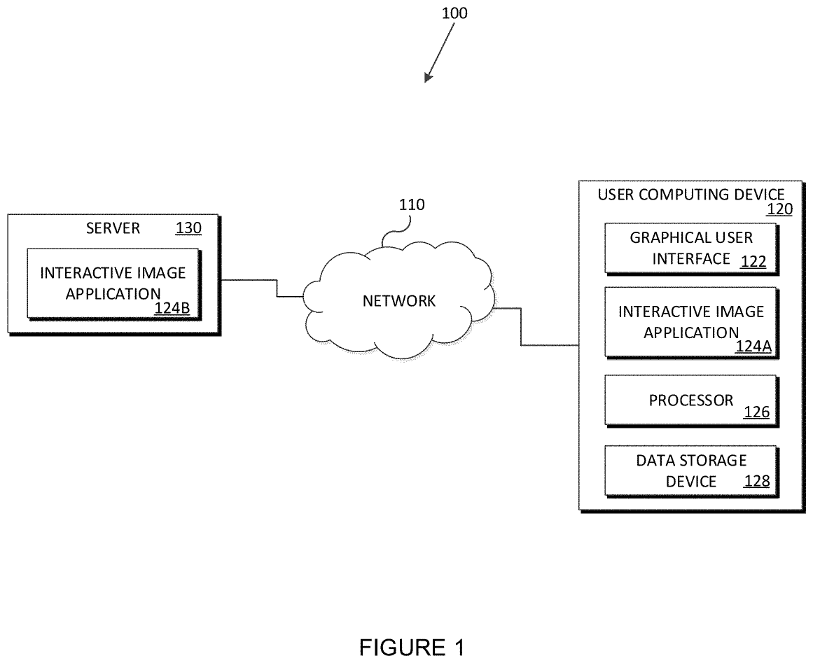

Referring to FIG. 1, a functional block diagram illustrating a system for an interactive image file format 100 is depicted, according to at least one embodiment. The interactive image file format 100 may include a user computing device 120 and a sever 130 interconnected via a network 110.

The network 110 may include various types of communication networks, such as a wide area network (WAN), a local area network (LAN), a telecommunication network, a wireless network, a public switched network and/or a satellite network. The network 110 may include connections, such as wire, wireless communication links, or fiber optic cables. It may be appreciated that FIG. 1 provides only an illustration of one implementation and does not imply any limitations with regard to the environments in which different embodiments may be implemented. Many modifications to the depicted environments may be based on design and implementation requirements.

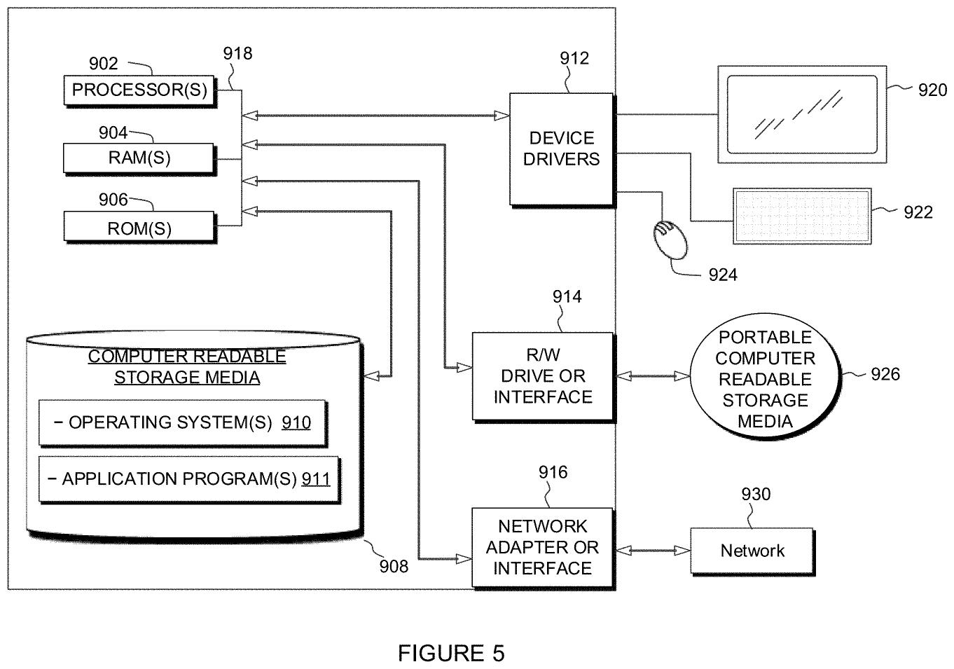

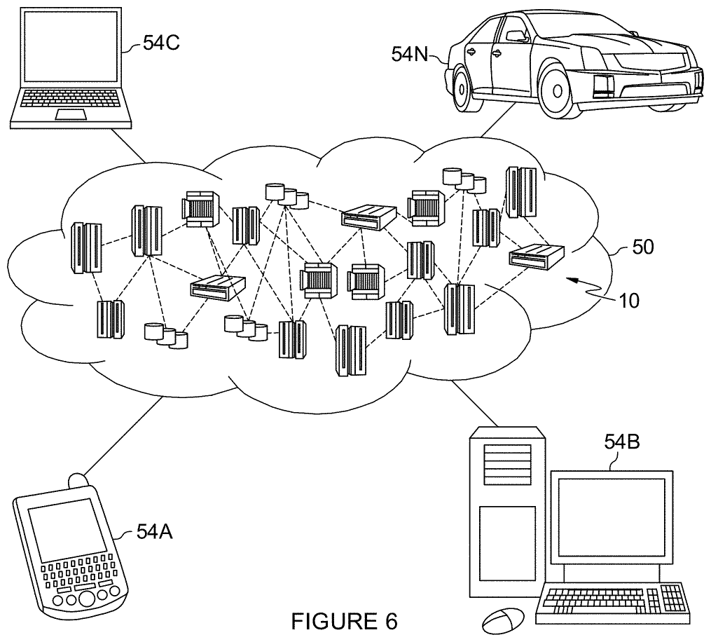

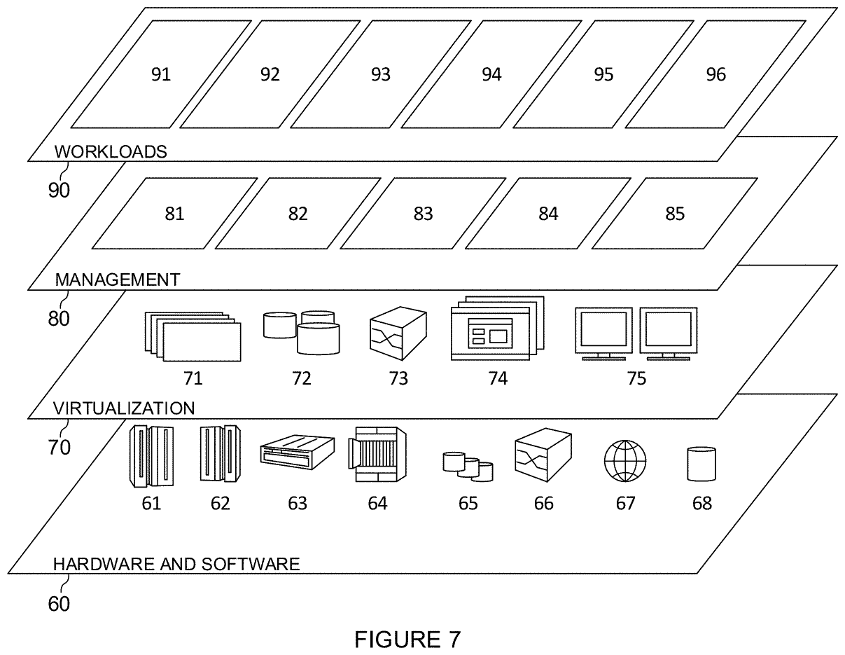

The user computing device 120 may include a graphical user interface 122, an interactive image application 124A, a processor 126 and a data storage device 128 that is enabled to host and run a software program, and communicate with the server 130 via the network 110, in accordance with one embodiment of the invention. The user computing device 120 may be, for example, a mobile device, a smart phone, a personal digital assistant, a netbook, a laptop computer, a tablet computer, a desktop computer, or any type of computing device capable of running a program and accessing a network. The user computing device 120 may be able to track movements using a global positioning system, WIFI tracking, an accelerometer, or other means to track the movements of the user computing device 120 in accordance with the user's interactions. The user computing device 120 may include internal and external hardware components, as described in further detail below with respect to FIG. 5. In other embodiments, the server 130 may operate in a cloud computing environment, as described in further detail below with respect to FIG. 6 and FIG. 7.

The user computing device 120 represents a computing device that may include a user interface, for example, a graphical user interface 122. The graphical user interface 122 can be any type of application that contains an interface capable of receiving user interactions and displaying the resulting images from the interactive image application 124A, for example, the application can be a web application, a graphical application, or any other type of application/program that allows a user to interact with and view the interactive image application 124A.

The server 130 may be a laptop computer, a netbook computer, a personal computer (PC), a desktop computer, or any programable electronic device or any network of programable electronic devices capable of hosting and running an interactive image application 124B and communicating with the user computing device 120 via the network 110, in accordance with embodiments of the invention. The server 130 may include internal and external hardware components, as depicted and described in further detail below with reference to FIG. 5. In other embodiments, the server 130 may operate in a cloud computing environment, as depicted in FIG. 6 and FIG. 7.

The interactive image application 124A, 124B may receive images and corresponding business logic from a program developer. Business logic may be code, script, or a visualization that explains how the image is to be displayed and what user events it can handle. An external application-programming interface may be called to activate different image blocks based on the response. For example, the script could be JavaScript and each image block could be a JavaScript object. The interactive image application 124A, 124B may then encode the images into image blocks. Image blocks may be different images stored within a single file at different offsets. For example, the images can be encoded in an existing image format, such as JPEG. Furthermore, the interactive image application 124A, 124B may generate a table of contents for the images. The table of contents may contain a list of all of the image blocks, the location of the image blocks in the file, and an identifier for each of the images. The identifier may contain addresses to different parts of the image. For example, the address could be a number identifier for the background or what is being displayed on the image. Additionally, the interactive image application 124A, 124B may create a single image file containing the image blocks, the corresponding business logic, and the table of contents. The image files may be stored in a repository. The interactive image application 124A, 124B may exist, either wholly or in part, on either the user computing device 120 or the server 130 or on both the user computing device 120 and the server 130.

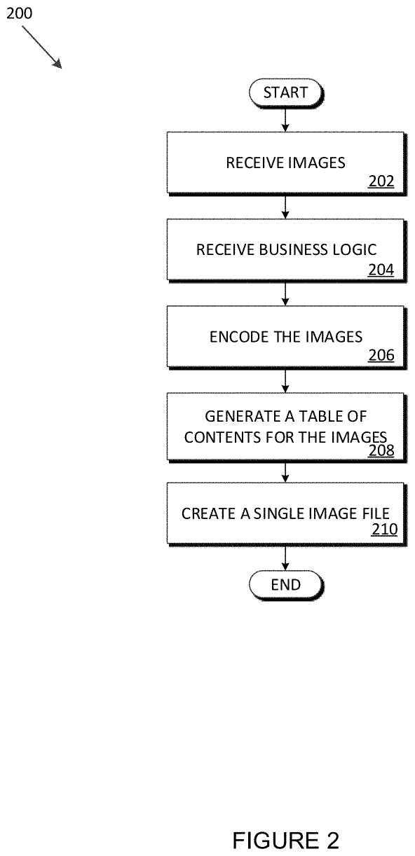

FIG. 2 is an operational flowchart 200 illustrating the system for generating the interactive image file format. At 202, the interactive image application 124A, 124B receives images. A program designer may create the images and transmit the images to the interactive image application 124A, 124B. For example, the interactive image application 124A, 124B may receive images for an advertisement, such as logos, phrases, messages, and any other images that may be part of the final image.

Then, at 204, the interactive image application 124A, 124B receives business logic associated with the received images. The interactive image application 124A, 124B may receive business logic from the program designer or a program developer. The business logic may be code, script, or a visualization that explains how the image is to be displayed and what user events it can handle. The business logic may call an external application-programming interface to activate different image blocks based on the response. The script could be JavaScript and each image block could be a JavaScript object. For example, the business logic could include script making an image clickable, telling one image to be hidden and another image to be displayed, telling one image to be displayed in a certain location, changing image color once clicked, and other such commands.

Next, at 206, the interactive image application 124A, 124B encodes the images. The interactive image application 124A, 124B may encode the images into image blocks. An image block may be different images stored within a single file at different offsets. The business logic may be encoded with the images, either along with the associated image block, or in a separate image block. The images could be encoded in an existing image format, such as JPEG. For example, the background for the final image may be encoded as an image block or an area to be displayed or hidden on the final image may be encoded as an image block.

Then, at 208, the interactive image application 124A, 124B generates a table of contents for the images. The table of contents may contain a list of all of the image blocks, the location of the image blocks in the file, and a provided identifier for each of the images. The identifier may contain addresses to different parts of the image. The identifier may be a numerical identifier. For example, the background of the final image may be located at offset 300.

Next, at 210, the interactive image application 124A, 124B creates a single image file. The interactive image application 124A, 124B may contain the table of contents, the business logic, and the image blocks. The table of contents, the business logic, and the image blocks may be merged together into a single file. For example, all of the image blocks associated with a final image may be stored in a single image file. Additionally, the user may interact with any single element of the interactive image and receive a variety of results. The single image file may be stored in a repository.

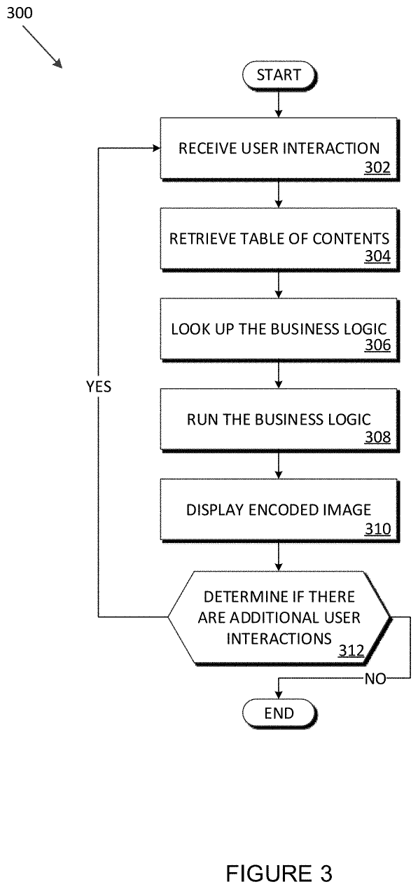

FIG. 3 is an operational flowchart 300 illustrating the implementation of an interactive image. At 302, the interactive image application 124A, 124B receives a user interaction from the user computing device 120. An interactive image may be displayed on the user computing device 120 through the graphical user interface 122. The user interaction may be any type of interaction with the interactive image, such as making a selection. The selection that the user makes may be transmitted to the interactive image application 124A, 124B. For example, the interactive image may instruct the user to make a selection in order to obtain a result.

Then, at 304, the interactive image application 124A, 124B retrieves the table of contents from the image file. The single image file for the interactive image that the user interacted with may be retrieved by the interactive image application 124A, 124B. The table of contents is stored within the single image file. The table of contents may contain the list of all of the image blocks, the location of the image blocks within the file, and the identifier for each of the image blocks. The table of contents is retrieved so that the image blocks associated with the interactive image may be identified. For example, the table of contents may be used to determine which image block was selected.

Next, at 306, the interactive image application 124A, 124B looks up the business logic using the table of contents. The table of contents may be used in order to determine which image block the user interacted with. The business logic may be found in the single image file, either along with the associated image block, or in a separate block of the single image file, referenced in the table of contents. For example, the business logic for the image block that the user interacted with may be found by the interactive image application 124A, 124B.

Then, at 308, the interactive image file format 124A, 124B runs the business logic. The interactive image application 124A, 124B may determine a response to the user interaction based on the business logic. The business logic may tell the interactive image application 124A, 124B how to respond to the user interaction. The response may comprise any action that the interactive image application 124A, 124B performs based on the user interaction. For example, the selection the user made may indicate a change in color based on the business logic for the particular image block.

Next, at 310, the interactive image application 124A, 124B displays the encoded image on the user computing device 120. Based on the business logic of the image block, the interactive image application 124A, 124B may display the corresponding encoded image on the user computing device 120 through the graphical user interface 122. For example, the interactive image application 124A, 124B may change the color of the image selected from black to green.

Then, at 312, the interactive image application 124A, 124B determines whether there are additional user interactions. The interactive image application 124A, 124B may determine whether there are any additional user interactions by monitoring the user computing device 120, such as a mouse, a keyboard, or a touchscreen for any movement or key press over a preconfigured period of time. When it has been determined that there are additional user interactions (step 312, “Yes” branch), the interactive image application 124A, 124B may receive the additional user interactions from the user computing device 120. This may be an iterative process until there are no more user interactions. When it has been determined that there are no additional user interactions (step 312, “No” branch), the implementation of the interactive image 300 may terminate after a preconfigured period of time. For example, the interactive image application 124A, 124B may receive another interaction from the user computing device 120. The user may have made a new selection on the interactive image.

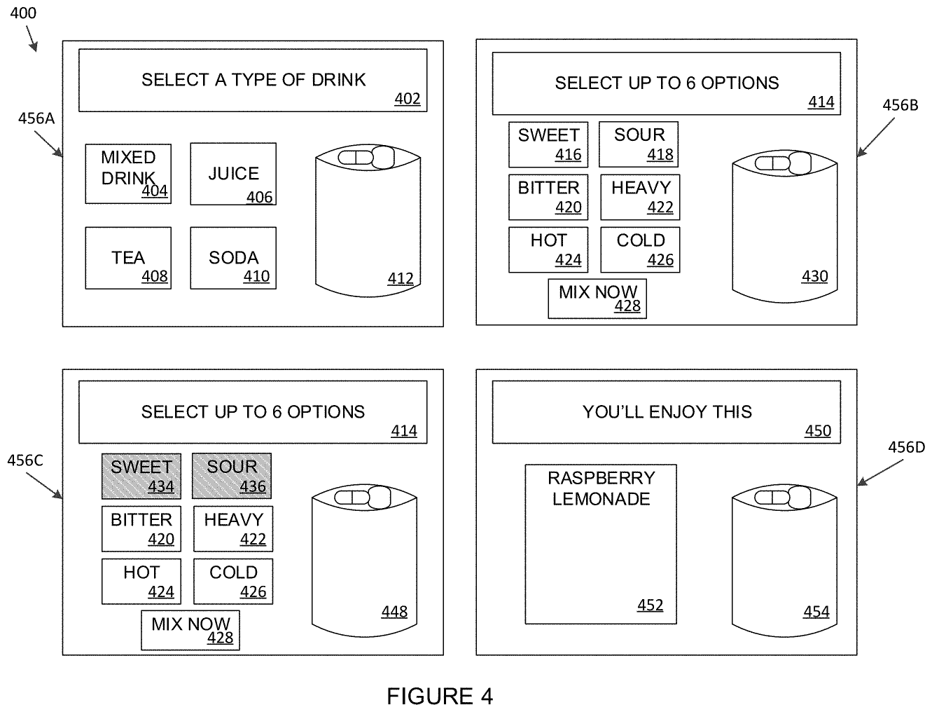

FIG. 4 illustrates an example interactive image function block diagram 400 according to one embodiment of the invention. Initial interactive image 456A, secondary interactive image 456B, user selected secondary interactive image 456C, and final interactive image 456D represent examples of the interactive image at different stages during user interaction. The examples 456A, 456B, 456C, and 456D for the interactive image may be for an interactive image to create a drink based on user interactions. The initial interactive image 456A may include a message 402, such as “Select a type of drink”, a set of options (e.g., a “mixed drink” option 404, a “juice” option 406, a “tea” option 408, and a “soda” option 410), and a product image 412, such as drink can. The initial interactive image 456A may include a message 402 that prompts the user to perform an action, such as “Select a type of drink”. The user may make this selection on the user computing device 120 via the graphical user interface 122. The user may then select one or more available product options. For example, if the product is a drink, the options depicted may be a “mixed drink” option 404, a “juice” option 406, a “tea” option 408, and a “soda” option 410. Based on the selection, the interactive image application 124A, 124B may determine how the interactive image will respond to the user selection. The product image 412 may be displayed to advertise a particular drink. For example, if the user selects “juice” 406, the interactive image application 124A, 124B may invoke the business logic and make the determination that the drink selection be stored in a program variable for future use, and that the example of the secondary interactive image 456B be displayed.

The example of the secondary interactive image 456B may include a message 414, such as “Select up to 6 options”, a set of options (a “sweet” option 416, a “sour” option 418, a “bitter” option 420, a “heavy” option 422, a “hot” option 424, and a “cold” option 426), an option button 428 for “mix now”, and a product image 430. The interactive image may prompt the user with the message 414 to “Select up to 6 options”. The user may make this selection on the user computing device 120 via the graphical user interface 122. The user may select up to 6 of the options. The options may include a “sweet” option 416, a “sour” option 418, a “bitter” option 420, a “heavy” option 422, a “hot” option 424, and a “cold” option 426. The interactive image may also display a “mix now” option 428 and the product image 430 advertising a particular drink. Based on the business logic of the image blocks, the interactive image application 124A, 124B may determine how to respond to the user making a selection, for example by storing the selection in a program variable and alter the selected boxes in the image. The result of this may be shown in the example of the user selected interactive image 456C.

The user selected interactive image 456C may include a message 414, such as “Select up to 6 options”, a set of options (a “sweet” option 434, a “sour” option 436, the “bitter” option 420, the “heavy” option 422, the “hot” option 424, and the “cold” option 426), a “mix now” option 428, and an updated product image 448. As with the example of the secondary interactive image 456B, the user was prompted by message 414 to “Select up to 6 options” out of the “sweet” option 434, the “sour” option 436, the “bitter” option 420, the “heavy” option 422, the “hot” option 424, and the “cold” option 426. The user may have selected the “sweet” option 434 and the “sour” option 436. The interactive image application 124A, 124B may have determined that the result of the user selecting the “sweet” option 434 and the “sour” option 436 image blocks is to shade the boxes to show that the options 434 and 436 have been selected. The user may then select “mix now” option 428 to get a result. In another embodiment, the user may also have the option to shake or move the user computer device 120 to mix the drink rather than selecting the “mix now” option 428. The user computing device 120 may use an accelerometer to detect the movement. The result of the user selecting the “mix now” option 428 may be shown in the example of the final interactive image 456D.

The example of the final interactive image 456D may include a message 450, such as “You'll enjoy this”, a result of the user interactions 452, for example the “Raspberry Lemonade” product 452, and a product image 454. The interactive image application 124A, 124B may determine the result of the user selecting the “mix now” option 428. The interactive image displays a message 450 saying “You'll enjoy this!” as the result of the user selecting a type of drink and selecting the options of the drink the user desires. Based on the business logic of selecting the “juice” option 406 and the “sweet” option 434 and the “sour” option 436, the interactive image application 124A, 124B may display the result of the created drink. The result of the created drink may be the “Raspberry lemonade” product 452 and the product image 454 may display a can of raspberry lemonade. The result can be retrieved from a map of user selections to drink recommendations stored inside the business logic, or from the response to a call to a remote application program interface initiated by the business logic. The result of the created drink may be displayed on the user computing device 120 via the graphical user interface 122.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the one or more embodiment, the practical application or technical improvement over technologies found in the marketplace, or to enable others of ordinary skill in the art to understand the embodiments disclosed herein.

FIG. 5 depicts a block diagram of components of the user computing device 120 of the system for the interactive image file format 100 of FIG. 1, in accordance with an embodiment of the present invention. It should be appreciated that FIG. 5 provides only an illustration of one implementation and does not imply any limitations with regard to the environments in which different embodiments may be implemented. Many modifications to the depicted environment may be made.

The user computing device 120 and/or the server 130 may include one or more processors 902, one or more computer-readable RAMs 904, one or more computer-readable ROMs 906, one or more computer readable storage media 908, device drivers 912, read/write drive or interface 914, network adapter or interface 916, all interconnected over a communications fabric 918. The network adapter 916 communicates with a network 930. Communications fabric 918 may be implemented with any architecture designed for passing data and/or control information between processors (such as microprocessors, communications and network processors, etc.), system memory, peripheral devices, and any other hardware components within a system.

One or more operating systems 910, and one or more application programs 911, for example, the interactive image application 124A, 124B (FIG. 1), are stored on one or more of the computer readable storage media 908 for execution by one or more of the processors 902 via one or more of the respective RAMs 904 (which typically include cache memory). In the illustrated embodiment, each of the computer readable storage media 908 may be a magnetic disk storage device of an internal hard drive, CD-ROM, DVD, memory stick, magnetic tape, magnetic disk, optical disk, a semiconductor storage device such as RAM, ROM, EPROM, flash memory or any other computer-readable tangible storage device that can store a computer program and digital information.

The user computing device 120 and/or the server 130 may also include a R/W drive or interface 914 to read from and write to one or more portable computer readable storage media 926. Application programs 911 on the user computing device 120 and/or the server 130 may be stored on one or more of the portable computer readable storage media 926, read via the respective R/W drive or interface 914 and loaded into the respective computer readable storage media 908.

The user computing device 120 and/or the server 130 may also include a network adapter or interface 916, such as a Transmission Control Protocol (TCP)/Internet Protocol (IP) adapter card or wireless communication adapter (such as a 4G wireless communication adapter using Orthogonal Frequency Division Multiple Access (OFDMA) technology). Application programs 911 on the user computing device 120 and/or the server 130 may be downloaded to the computing device from an external computer or external storage device via a network (for example, the Internet, a local area network or other wide area network or wireless network) and network adapter or interface 916. From the network adapter or interface 916, the programs may be loaded onto computer readable storage media 908. The network may comprise copper wires, optical fibers, wireless transmission, routers, firewalls, switches, gateway computers and/or edge servers.

The user computing device 120 and/or the server 130 may also include a display screen 920, a keyboard or keypad 922, and a computer mouse or touchpad 924. Device drivers 912 interface to display screen 920 for imaging, to keyboard or keypad 922, to computer mouse or touchpad 924, and/or to display screen 920 for pressure sensing of alphanumeric character entry and user selections. The device drivers 912, R/W drive or interface 914 and network adapter or interface 916 may comprise hardware and software (stored on computer readable storage media 908 and/or ROM 906).

The programs described herein are identified based upon the application for which they are implemented in a specific embodiment of the invention. However, it should be appreciated that any particular program nomenclature herein is used merely for convenience, and thus the invention should not be limited to use solely in any specific application identified and/or implied by such nomenclature.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

It is to be understood that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported, providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure that includes a network of interconnected nodes.

Referring now to FIG. 6, illustrative cloud computing environment 50 is depicted. As shown, cloud computing environment 50 includes one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 6 are intended to be illustrative only and that computing nodes 10 and cloud computing environment 50 can communicate with any type of computerized device over any type of network and/or network addressable connection (e.g., using a web browser).

Referring now to FIG. 7, a set of functional abstraction layers provided by cloud computing environment 50 (FIG. 6) is shown. It should be understood in advance that the components, layers, and functions shown in FIG. 7 are intended to be illustrative only and embodiments of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may include application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and interactive image file formatting 96. Interactive image file formatting 96 may receive images and business logic and encode the images into image blocks. Interactive image file formatting 96 may also generate a table of contents for the image blocks and store the image blocks, business logic, and table of contents in a single image file.

Based on the foregoing, a computer system, method, and computer program product have been disclosed. However, numerous modifications and substitutions can be made without deviating from the scope of the present invention. Therefore, the present invention has been disclosed by way of example and not limitation.

While the invention has been shown and described with reference to certain exemplary embodiments thereof, it will be understood by those skilled in the art that various changes in form and details may be made therein without departing from the spirit and scope of the present invention as defined by the appended claims and their equivalents.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the one or more embodiment, the practical application or technical improvement over technologies found in the marketplace, or to enable others of ordinary skill in the art to understand the embodiments disclosed herein.

1. A method for an interactive image file, the method comprising:
receiving, by a computer, at least one image and a plurality of business logic associated with the at least one image;
encoding the at least one image and plurality of business logic associated with the at least one image into at least one image block, wherein the at least one image block contains at least one image stored within a single file at different offsets, and wherein the plurality of business logic defines display information and user event response information for the at least one image and utilizes an external application programming interface to activate image blocks;
generating a table of contents for the at least one image block, wherein the table of contents contains a list of the at least one image block, a location of the at least one image block, and an identifier for each of the at least one image block; and
creating a single image file for the interactive image file.

2. The method of claim 1, wherein the plurality of business logic is a code, a script, or a visualization that explains how the at least one image is to be displayed and a plurality of user events the at least one image is capable of processing.

3. The method of claim 1 further comprising:
providing the identifier for each at least one image block, wherein the identifier is a numerical identifier.

4. The method of claim 1, wherein the single image file contains the table of contents, the plurality of business logic, and the at least one image block.

5. The method of claim 4, further comprising:
storing the single image file in a repository.

6. The method of claim 1, further comprising:
receiving a user interaction with the interactive image file from a user computing device.

7. The method of claim 6, further comprising:
determining a response to the user interaction based on the table of contents, the plurality of business logic, and the at least one image block, wherein the response is an action performed based on the user interaction; and
in response to determining the response to the user interaction, executing the response on the user computing device.

8. A computer program product for the interactive image file, the computer program product comprising:
one or more non-transitory computer-readable storage media and program instructions stored on the one or more non-transitory computer-readable storage media capable of performing a method, the method comprising:
receiving, by a computer, at least one image and a plurality of business logic associated with the at least one image;
encoding the at least one image and plurality of business logic associated with the at least one image into at least one image block, wherein the at least one image block contains at least one image stored within a single file at different offsets, and wherein the plurality of business logic defines display information and user event response information for the at least one image and utilizes an external application programming interface to activate image blocks;
generating a table of contents for the at least one image block, wherein the table of contents contains a list of the at least one image block, a location of the at least one image block, and an identifier for each of the at least one image block; and
creating a single image file for the interactive image file.

9. The computer program product of claim 8, wherein the plurality of business logic is a code, a script, or a visualization that explains how the at least one image is to be displayed and a plurality of user events the at least one image is capable of processing.

10. The computer program product of claim 8, further comprising:
providing the identifier for each at least one image block, wherein the identifier is a numerical identifier.

11. The computer program product of claim 8, wherein the single image file contains the table of contents, the plurality of business logic, and the at least one image block.

12. The computer program product of claim 11, further comprising:
storing the single image file in a repository.

13. The computer program product of claim 8, further comprising:
receiving a user interaction with the interactive image file from a user computing device.

14. The computer program product of claim 13, further comprising:
determining a response to the user interaction based on the table of contents, the plurality of business logic, and the at least one image block, wherein the response is an action performed based on the user interaction; and
in response to determining the response to the user interaction, executing the response on the user computing device.

15. A computer system for the interactive image file, the computer system comprising:
one or more computer processors, one or more computer-readable storage media, and program instructions stored on one or more of the computer-readable storage media for execution by at least one of the one or more processors capable of performing a method, the method comprising:
receiving, by a computer, at least one image and a plurality of business logic associated with the at least one image;
encoding the at least one image and plurality of business logic associated with the at least one image into at least one image block, wherein the at least one image block contains at least one image stored within a single file at different offsets, and wherein the plurality of business logic defines display information and user event response information for the at least one image and utilizes an external application programming interface to activate image blocks;
generating a table of contents for the at least one image block, wherein the table of contents contains a list of the at least one image block, a location of the at least one image block, and an identifier for each of the at least one image block; and
creating a single image file for the interactive image file.

16. The computer system of claim 15, wherein the plurality of business logic is a code, a script, or a visualization that explains how the at least one image is to be displayed and a plurality of user events the at least one image is capable of processing.

17. The computer system of claim 15, further comprising:
providing the identifier for each at least one image block, wherein the identifier is a numerical identifier.

18. The computer system of claim 15, wherein the single image file contains the table of contents, the plurality of business logic, and the at least one image block.

19. The computer system of claim 18, further comprising:
storing the single image file in a repository.

20. The computer system of claim 15, further comprising:
receiving a user interaction with the interactive image file from a user computing device.
